(19) United States
(12) Patent Application Publication
(10) Pub. No.: US 2007/0107597 A1
(43) Pub. Date: May 17, 2007

(54) Air Purifying Device

(75) Inventor: Yue San CHEUNG, Kowloon, Hong Cong (CN)

Correspondence Address: WILLIAM J. SAPONE;COLEMAN SUDOL SAPONE P.C., 714 COLORADO AVENUE, BRIDGE PORT, CT, 06605, US

(73) Assignee: LIFE AIR IAQ LIMITED, Kowloon (CN)

(21) Appl. No.: 11/551,099

(22) Filed: Oct. 19, 2006

(30) Foreign Application Priority Data
Nov. 11, 2005 (HK) 05110094.9

(51) Int. Cl. B03C 3/38; B01D 47/00

(52) U.S. Cl. 96/16; 96/223

(57) ABSTRACT

An air purifying device is disclosed as including a plurality of fins coated with 5 titanium dioxide (TiO₂) and positioned substantially parallel to one another to define at least one passageway allowing air to pass through, and a source of ultraviolet (UV) light, in which each of the fins has a hole and two ends, at least part of the UV light source is received within a channel defined by the holes of the fins, and each of the two ends of each fin has two bent portions.

### FIELD OF THE PRESENT INVENTION

This invention relates to an air purifying device, particularly such a device within fins or plates coated with titanium dioxide (TiO₂). The invention further relates to an air purifying apparatus including such an air purifying device.

### BACKGROUND OF THE PRESENT INVENTION

Air purifiers working on photo-catalytic oxidation (PCO) mechanism are known. It is known that when TiO2 is exposed to ultraviolet (UV) radiation, electron hole pairs are created. The resulting free radicals, e.g. hydroxyl radicals (.OH) and superoxide ions (O₂⁻), are very efficient oxidizers of organic matter, and are thus capable of decomposing various organic compounds. In particular, such free radicals are found to be able to kill a number of fungi, mold, bacteria and viruses, deodorize, and decompose such volatile organic compounds (VOCs) as benzene and formaldehyde.

Representative constructions of conventional air purifiers are shown in FIGS. 1 to 3 hereof. All of these constructions have a UV light source and a number of structures coated with titanium dioxide. As shown in FIGS. 1 to 3, these constructions differ from each other mainly in the relative positioning of the titanium dioxide coated structures and the UV light source.

In the construction shown in FIG. 1, air flow passes through a mesh 10 coated with TiO₂, which is also illuminated by a UV light source 12. The shortcomings of such an arrangement include:
short contact time between the air flow (and thus the harmful substances carried by the air) and the TiO₂ coating;
such a purifier is generally rather thick;
there is a high air resistance or, in other words, a greater pressure drop; and
some portions of the mesh 10 are not exposed to UV radiation, such that the coating of TiO₂ on such portions is wasted.

As to the construction shown in FIG. 2, a TiO₂ coated honeycomb structure 16 is illuminated by a UV light source 18. Such an arrangement suffers from the following disadvantages:
leakage of UV radiation;
such a purifier is generally rather thick; and
some portions of the honeycomb structure 16 are not exposed to UV radiation, such that the coating of TiO₂ on such portions is wasted.

Turning to the construction shown in FIG. 3, a number of parallel TiO₂ coated fins 20 are illuminated by a UV light source 22. The shortcomings of this prior art arrangement are similar to those of the construction shown in FIG. 2.

It is thus an object of the present invention to provide an air purifying device, and an air purifying apparatus including such an air purifying device, in which the aforesaid shortcomings are mitigated, or at least to provide a useful alternative to the trade and public.

### SUMMARY OF THE PRESENT INVENTION

According to a first aspect of the present invention, there is provided an air purifying device including a plurality of fins coated with titanium dioxide (TiO₂) and positioned substantially parallel to one another to define at least one passageway allowing air to pass through; and a source of ultraviolet (UV) light; wherein each of said fins has a hole and two ends; wherein at least part of said UV light source is received within a channel defined by said holes of said fins; and wherein each of said two ends of each said fin has two bent portions.

According to a second aspect of the present invention, there is provided an air purifying apparatus including at least an air purifying device, at least an air inlet, and at least an air outlet, wherein said air inlet and said air outlet are in a gas communicable relationship with said at least one passageway of said device, wherein said air purifying device includes a plurality of fins coated with titanium dioxide (TiO₂) and positioned substantially parallel to one another to define at least one passageway allowing air to pass through; and a source of ultraviolet (UV) light; wherein each of said fins has a hole and two ends; wherein at least part of said UV light source is received within a channel defined by said holes of said fins; and, wherein each of said two ends of each said fin has two bent portions.

### BRIEF DESCRIPTION OF THE DRAWINGS

Preferred embodiments of the present invention will now be described, by way of examples only, with reference to the accompanying drawings, in which:

FIG. 1 is a schematic diagram of a first conventional air purifying device;

FIG. 2 is a schematic diagram of a second conventional air purifying device; FIG. 3 is a schematic diagram of a third conventional air purifying device;

FIG. 4 is a schematic diagram of an air purifying device according to the present invention;

FIG. 5A is a front view of the air purifying device shown in FIG. 4;

FIG. 5B is a side view of the air purifying device shown in FIG. 4;

FIG. 6 is a sectional view taken along the line A-A in FIG. 5A;

FIG. 7 is a front view of a fin of the air purifying device shown in FIG. 4;

FIG. 8 is an enlarged side view of part of the edge of the fin shown in FIG. 7;

FIG. 9A is an enlarged top view of a first kind of protuberance on the fin shown in FIG. 7.

FIG. 9B is an enlarged top view of a second kind of protuberance on the fin shown in FIG. 7;

FIG. 10A is a sectional view taken along the line B-B of FIG. 9A, and that taken along the line D-D of FIG. 9B;

FIG. 10B is a sectional view taken along the line C-C of FIG. 9A, and that taken along the line E-E of FIG. 9B;

FIG. 11 shows the positioning of a number of fins in the air purifying device of FIG. 4;

FIG. 12 shows the movement of air through the passageways between the fins shown in FIG. 11;

FIG. 13 shows an enlarged view of a UV blocking structure along one side of the fins shown in FIG. 11;

FIG. 14A shows a first arrangement of the fins in an air purifying device according to the present invention;

FIG. 14B shows a second arrangement of the fins in an air purifying device according to the present invention;

FIG. 14C shows a third arrangement of the fins in an air purifying device according to the present invention;

FIG. 15 shows a schematic diagram of a first air purifying apparatus according to the present invention including the air purifying device of FIG. 4;

FIG. 16 shows a schematic diagram of a second air purifying apparatus according to the present invention including the air purifying device of FIG. 4; FIG. 17 shows a schematic diagram of a third air purifying apparatus according to the present invention including the air purifying device of FIG. 4; and FIG. 18 shows a schematic diagram of a fourth air purifying apparatus according to the present invention including the air purifying device of FIG. 4.

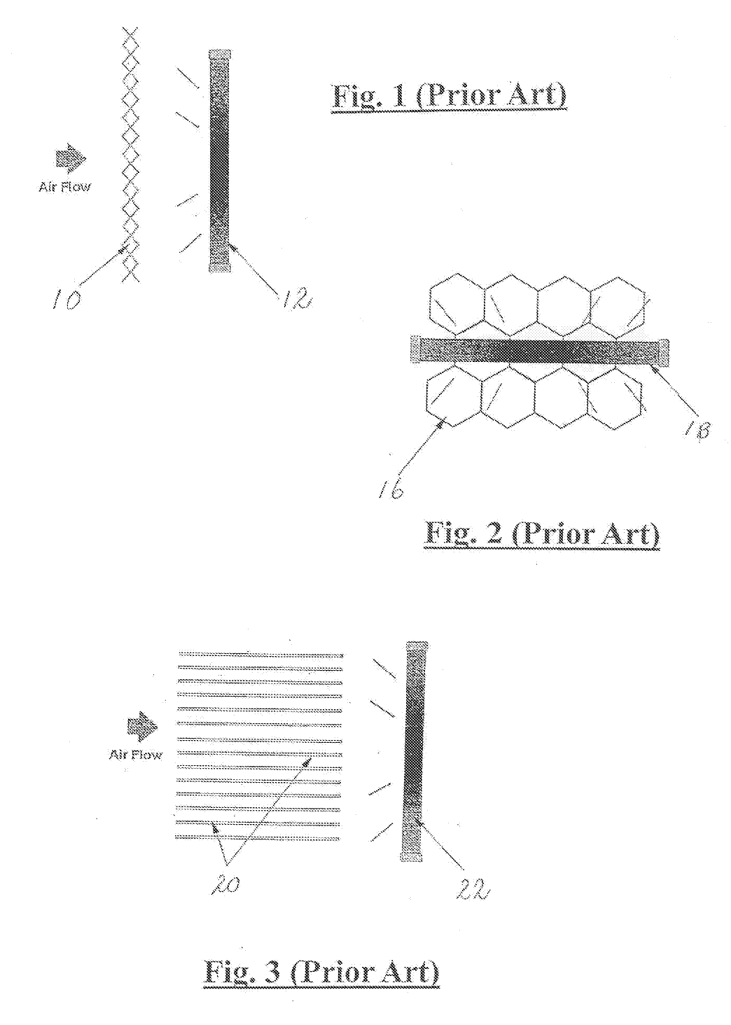

### DETAILED DESCRIPTION OF PREFERRED EMBODIMENTS OF THE INVENTION

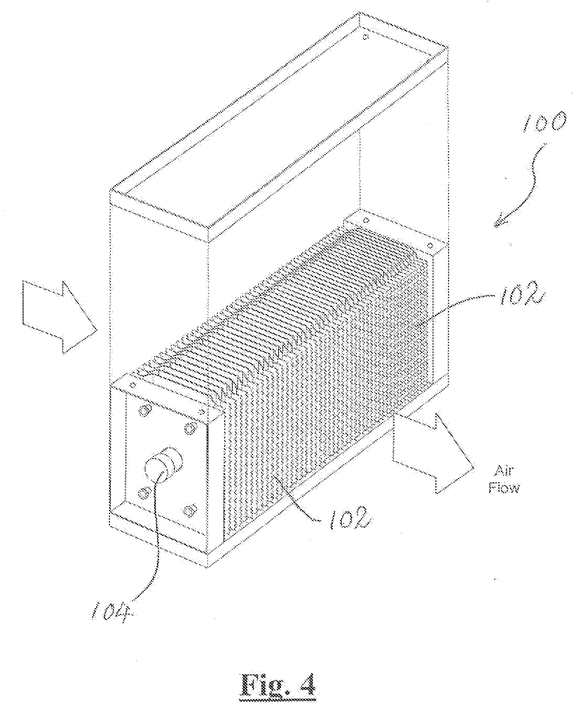

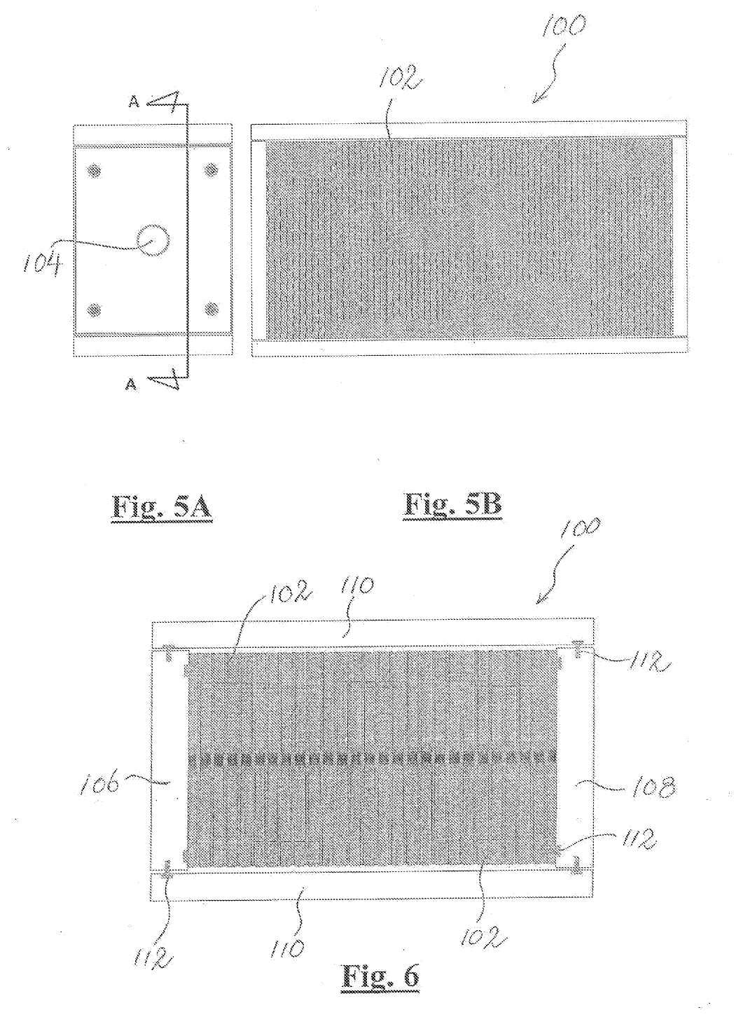

An air purifying device according to the present invention is shown in FIGS. 4, 5A and 58, and generally designated as 100. The device 100 includes a number of plates or fins 102 coated with titanium dioxide (TiO₂). The fins 102 are arranged within the device 100 parallel to one another. An ultraviolet (UV) light source 104 is positioned through the TiO2 coated fins 102, emitting UV radiation of a wavelength of 360 nm to 380 nm. Each of the fins 102 is provided with a hole (not seen in FIGS. 4, 5A or 58) such that when the fins 102 are assembled as shown in FIGS. 4 and 58, the holes collectively define a channel through which the UV light source 104 is received.

It can be seen that when the fins 102 are assembled as shown in FIGS. 4 and 58, a number of passageways are defined among the fins 102 allowing air to pass through, as shown in FIG. 4. Generally speaking, the air leaving the passageways among the fins 102 forming part of the air purifying device 100 is cleaner than that entering the passageways among the fins 102.

As shown in FIG. 6, the device 100 has a front cover 106, a rear cover 108 and two side covers 11b inter-engaged with one another and with the fins 102 by screws 112, for enclosing the fins 102, such that only two sides of the fins 102 are exposed outside the device 100. In such an arrangement, a first of the two exposed sides of the fins 102 serves as an inlet of air into the passageways among the fins 102, and a second of the two exposed sides of the fins 102 serves as an outlet of air from the passageways among the fins 102.

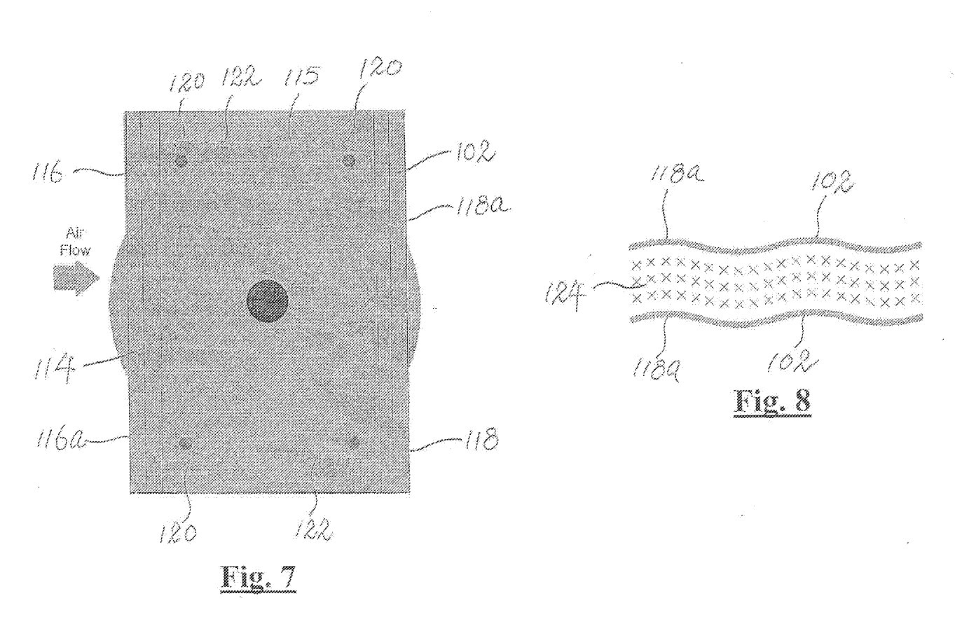

As shown in FIG. 7, a fin 102 of the air purifying device 100 is generally rectangular in shape and has a central through hole 114 for receiving the UV light source 104. Air flows across the surface 115 of the fin 102 from a first side 116 to a second side 118. On the surface of the fin 102 are a number of protuberances 120, 122, to be further discussed below. The edge 116a of the side 116 and the edge 118a of the side 118 are waved, as shown in FIG. 8. Such an arrangement increases the contact surface area between the air and the fins 102, enhances the generation of air turbulence in the passageway 124 between the fins 102 (thus promoting contact of the air with the fins 102), and increases the physical strength of the fins 102, as it can minimize deflection of the fins 102 by the air pressure of the incoming air.

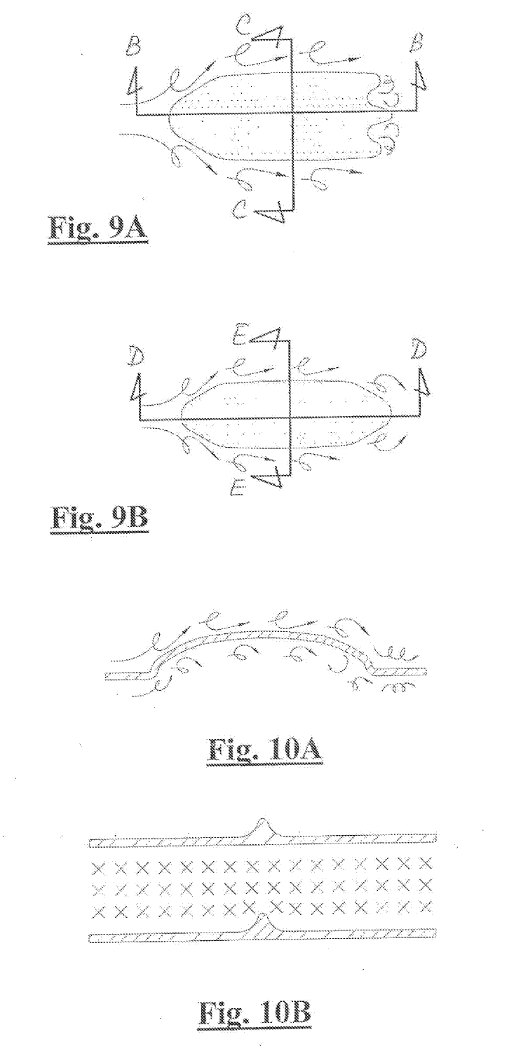

As discussed above, a number of protuberances 120, 122 are provided on the surface of the fin 102. FIG. 9A shows an enlarged top view of the protuberance 120, and FIG. 9B shows an enlarged top view of the protuberance 122. It can be seen in FIGS. 9A to 10B that the existence of these protuberances 120, 122 causes the air passing by to generate turbulence, thus increasing the time of contact between the air and the TiO2 coated fins 102. Similar effect can be achieved by providing troughs or recesses on the surface 115 of the fins 102. It is also envisaged that the surface 115 of the fins 102 may be provided with both protuberances 120, 122 and recesses.

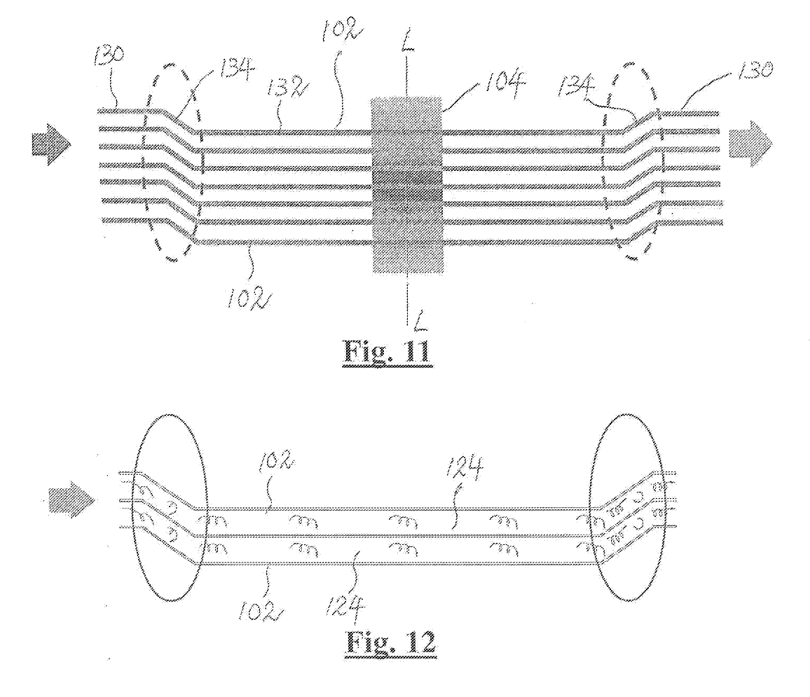

As discussed above, two sides of the fins 102 are exposed outside the air purifying device 100. In order to prevent leakage of UV radiation to the outside, along each such side of each fin 102 is formed a UV radiation blocking structure. As shown in FIG. 11, each of the fin 102 is in a wing-like shape, with two raised outer strips 130 joined with a lower central major surface 132 each via a slanted strip 134.

It can be seen in FIG. 11 that the longitudinal axis of the UV light source 104 coincides with the central longitudinal axis L-L of the fins 102.

Thus, it can be seen that each exposed side of the fins 102 has a portion which is bent twice, namely the inclined strip 134 which is bent relative to the central surface 132 towards the axis L-L, and the raised strip 130 which is bent relative to the inclined strip 134 away from the axis L-L. The raised strips 130 and the central surface 132 are parallel with each other but not co-planar.

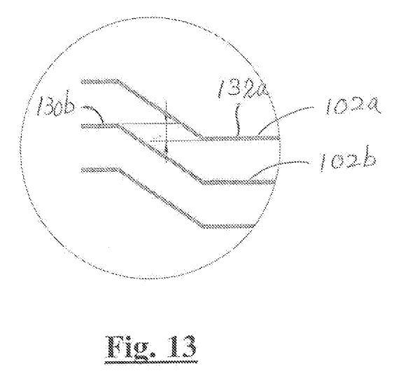

By way of such an arrangement, a bent passageway 124 is formed between each pair of adjacent fins 102, which further enhances the formation of turbulence in the air passing therethrough, as shown in FIG. 12.

In addition, the bent portions at the two exposed sides of the fins 102 serve the additional purpose of preventing leakage of UV radiation away from the fins 102. All or at least most of the UV radiation from the UV light source 104 will be reflected by the fins 102, in particular by the inclined strips 134, back towards the UV light source 104, and thus be kept within the passageways 124 formed among the fins 102. To achieve such an effect, it is found that the central surface 132a of a fin 102a must be below the level of the raised strip 130b of an adjacent fin 102b, as shown in FIG. 13.

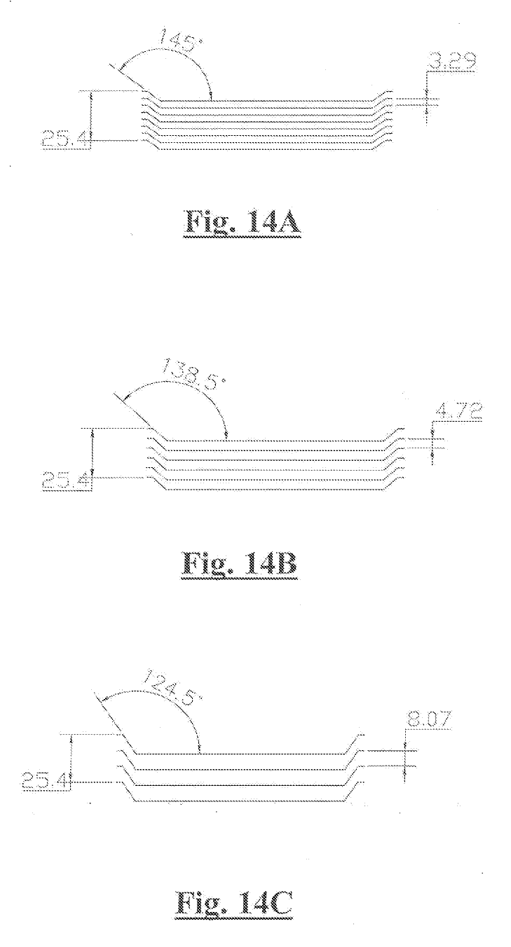

Several exemplary fin arrangements and dimensions are shown in FIGS. 14A to 20 14C. In FIG. 14A, an 8-fin-per-inch arrangement is shown, in which adjacent fins are separated by a distance of 3.29 mm so that there are eight fins for each 25.4 mm. The inclined strips are inclined relative to the central major surface at an angle of 145°. In FIG. 14B, a 6-fin-per-inch arrangement is shown, in which adjacent fins are separated by a distance of 4.72 mm so that there are six fins for each 25.4 mm.

The inclined strips are inclined relative to the central major surface at an angle of 138.5°. In FIG. 14C, a 4-fin-per-inch arrangement is shown, in which adjacent fins are separated by a distance of 8.07 mm so that there are four fins for each 25.4 mm. The inclined strips are inclined relative to the central major surface at an angle of 124.5°.

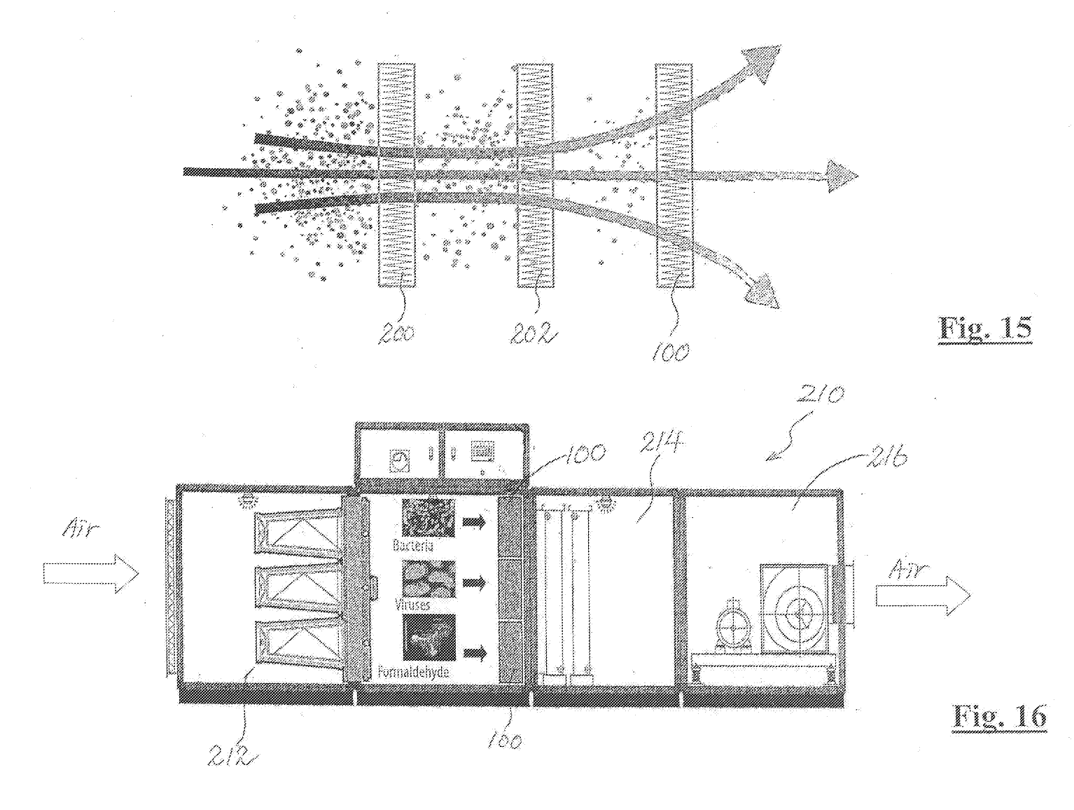

The air purifying device 100 may be used in a number of air purifying apparatus. As a general arrangement, and as shown in FIG. 15, the air purifying device 100 may be positioned downstream of a pre-filter 202 for filtering out dust, and a secondary filter 204 for filtering out finer dust, pollen, molds, dust mile and the like. The device 100 may then decompose the remaining bacteria, viruses, VOCs and odors.

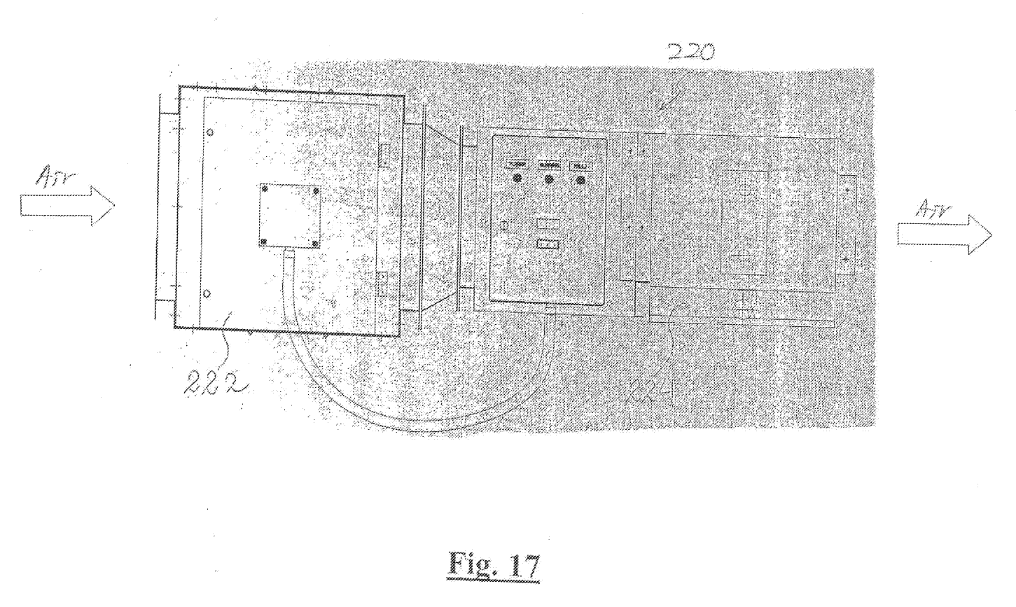

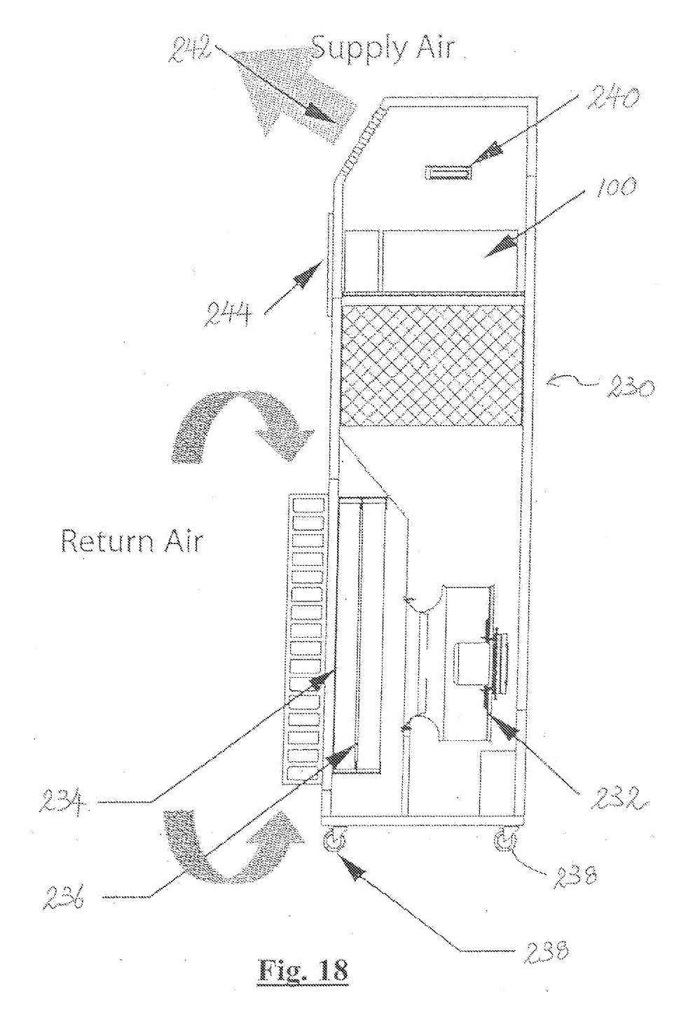

The air purifying device 100 may form part of an air handling unit (AHU) 210, as shown in FIG. 16. Air entering the AHU 210 first passes through an auto-cleaning high efficiency air filtration system with control 212, then through one of a number of air purifying devices 100. The filtered and cleaned air then passes through a coil section 214, to be supplied to the outside environment through an air delivering section 216.

As an alternative, the air purifying device 100 may form part of a fan coil unit (FCU) system, generally designated as 220 in FIG. 17. In such an arrangement, a number of devices 100 are fitted into the housing of the FCU side by side with the flange of the FCU at one end and the return plenum at another end. Return air is first treated by the devices 100 contained within a housing 222, and then exits the system 220 through a fan coil unit 224 as supply air.

The air purifying device 100 may also be formed as a standalone machine, e.g. for domestic, commercial or industrial use, as shown in FIG. 18, and generally designated as 230. Return air is drawn into the interior of the machine 230 by a blower 232. Such air is pre-treated by a pre-filter 234 and a secondary filter 236 (e.g. as shown in FIG. 15 and discussed above). Such pre-treated and filtered air is then passed to one or a number of air purifying devices 100, downstream of the pre-filter 234 and secondary filter 236, for further sterilization. The machine 230 further includes a number of wheels 238 for allowing movement of the machine 230 and a positive-temperature coefficient (PTC) heater 240. Air so treated then exits the machine 230 to the outside environment via a diffuser 242. The operation of the machine 230 may be controlled by operating a light-touch control panel 244.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. An air purifying device including:
a plurality of fins coated with titanium dioxide (TiO₂) and positioned substantially parallel to one another to define at least one passageway allowing air to pass through; and
a source of ultraviolet (UV) light;
wherein each of said fins has a hole and two ends;
wherein at least part of said UV light source is received within a channel defined by said holes of said fins; and
wherein each of said two ends of each said fin has two bent portions.

2. A device according to claim 1 wherein at each end of each said fin, a first bent portion is bent towards a central longitudinal axis of said fin and a second bent portion is bent away from said central longitudinal axis of said fin.

3. A device according to claim 2 wherein said central longitudinal axis of said fin is substantially parallel to a longitudinal axis of said UV light source.

4. A device according to claim 1 wherein each said fin has at least two parallel portions joined by an inclined portion.

5. A device according to claim 4 wherein said two parallel portions lie on different planes.

6. A device according to claim 5 wherein one of the parallel portions of a fin is between the parallel portions of an adjacent fin.

7. A device according to claim 4 wherein each said find has three parallel portions joined by two inclined portions.

8. A device according to claim 7 wherein two said parallel portions lie on substantially the same plane.

9. A device according to claim 1 wherein at least part of an edge of at least one said fin is in a wave shape.

10. A device according to claim 1 wherein at least a trough or protuberance is provided on a major surface of at least one said fin.

11. A device according to claim 10 wherein at least one said fin includes a plurality of troughs or protuberances.

12. An air purifying apparatus including at least an air purifying device according to claim 1, at least an air inlet, and at least an air outlet, wherein said air inlet and said air outlet are in a gas communicable relationship with said at least one passageway of said device.

13. An apparatus according to claim 12 further including at least one filter upstream of said air purifying device.
